(19) United States
(12) Patent Application Publication
(10) Pub. No.: US 2016/0019734 A1
(43) Pub. Date: Jan. 21, 2016

(54) HANDS-FREE TRUNK RELEASE AND VEHICLE ENTRY

(71) Applicant: Lear Corporation, Southfield, MI (US)

(72) Inventors: Jason G. BAUMAN, Birmingham, MI (US); Ronald O. KING, Brownstown, MI (US); Thomas M. O'BRIEN, Troy, MI (US); Stephen M. HUMPHREY, Royal Oak, MI (US)

(21) Appl. No.: 14/790,127

(22) Filed: Jul. 2, 2015

Related U.S. Application Data
(60) Provisional application No. 62/024,879, filed on Jul. 15, 2014.

(51) Int. Cl. G07C 9/00

(52) U.S. Cl. CPC G07C 9/00007; G07C 9/00309; G07C 2009/00769

(57) ABSTRACT

A remote keyless entry system including a keyless fob having a transmitter for remote transmission of a semi-passive function control signal to an automobile in which the user does not have to manually actuate the fob while it transitions with the user from a point outside of its semi-passive range with respect to the automobile to a point within its semi-passive range. The user need only actuate the semi-passive signal transmission once and it is repetitively transmitted for a given amount of time whereby the trunk lid for example of the user's automobile will open as the user and the keyless fob move into a predetermined range from the automobile. A vehicle receive may initiate the function only once despite receiving repeated transmissions of the semi-passive function control signal from the fob within the semi-passive range.

### CROSS-REFERENCE TO RELATED APPLICATIONS

This application claims the benefit of U.S. provisional application Ser. No. 62/024,879 filed Jul. 15, 2014, the disclosure of which is incorporated in its entirety by reference herein.

### TECHNICAL FIELD

The present disclosure relates to an improved keyless fob as used in conjunction with a vehicle receiving module which opens the vehicle door locks and/or trunk, for example, in response to transmissions from the fob.

### BACKGROUND

Systems for unlocking automobile doors and trunks include conventional keys, coded keypads on the automobile itself, and lock systems that employ remote transmission, for example, from a key fob. While conventional keys and coded keypads may provide high security, many drivers today prefer to use keyless fobs for their greater convenience. Such fobs generally include one or more pushbutton keys or signal actuators that, when pressed, cause the fob to emit a coded transmission including both an identification code for the particular fob and information to authorize the execution of a particular action or vehicle function, e.g. unlocking the automobile doors or opening the trunk. A control module or receiver on the automobile corresponding to the fob picks up the coded transmission and decodes it. Such a control module constitutes, or is part of, the general electronic module (GEM) controlling the electrical system of the automobile and powered by the standard automobile battery. If the identification code in the transmission identifies the fob as one assigned to that automobile, the control module causes the electrical system of the automobile to execute the indicated action. As a result, the driver of the automobile can unlock the door and/or the trunk for example as he or she approaches the automobile. Such lock systems are referred to as remote keyless entry (RKE) systems.

Typically, RKE or keyless fob systems for automobiles are designed so that a user can push a fob button and actuate a vehicle function from at least a certain distance from the vehicle. Often, a situation occurs when a user's hands may not be free to push a fob button as the user approaches the related automobile. For example, a user may be carrying bags of groceries whereby the fob could not be actuated without having to unload the bags first; or, before picking up the bags the user may be beyond the range of the fob signal being received. Even if the fob was operable at a distance significantly greater than the typical 10 to 50 meters range from the vehicle, the user may not feel comfortable opening his/her trunk or doors at such a distance and then having to approach the vehicle with hands encumbered.

### SUMMARY

Accordingly, the object of the present disclosure is to provide a semi-passive keyless fob entry system for an automobile wherein vehicular functions can be preprogramed to occur in a hands free fashion as the user approaches the vehicle.

It is another object of the present disclosure to provide a keyless fob to operate in the above manner wherein the preprogrammed vehicular function will occur only when the user is within a relatively close, predetermined distance of the vehicle; in this manner, the user could return to a grocery store, for example, if something has been forgotten and not have to be concerned about placing bags down and re-locking the doors or trunk of the automobile involved.

It is yet another object of the present disclosure to provide a keyless fob for an automobile which does not in any way compromise the user's safety in the sense of having preprogrammed functions occur prematurely in a hands free manner as the user approaches an automobile.

It is still another object of the present disclosure to provide a keyless fob entry system for an automobile (or any device or structure) in which the hands free mode of operation can easily and conveniently be used with the conventional manual mode of operation of such fobs (i.e., wherein a button is simply pushed within the operating range of the fob with respect to the vehicle to immediately cause a vehicular function to occur).

It is still yet another object of the present disclosure to provide a semi-passive keyless fob entry system that continually transmits commands to the vehicle to perform a vehicle function, such as door unlock or trunk release, while only triggering one activation of the door unlock motor or trunk release per semi-passive event.

### BRIEF DESCRIPTION OF THE DRAWINGS

FIG. 1 is a schematic overview of the various operating ranges associated with a keyless fob in accordance with one or more embodiments of the present disclosure; and

FIG. 2 is simplified block diagram of a keyless fob and vehicle receiver in accordance with one or more embodiments of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments of the present disclosure.

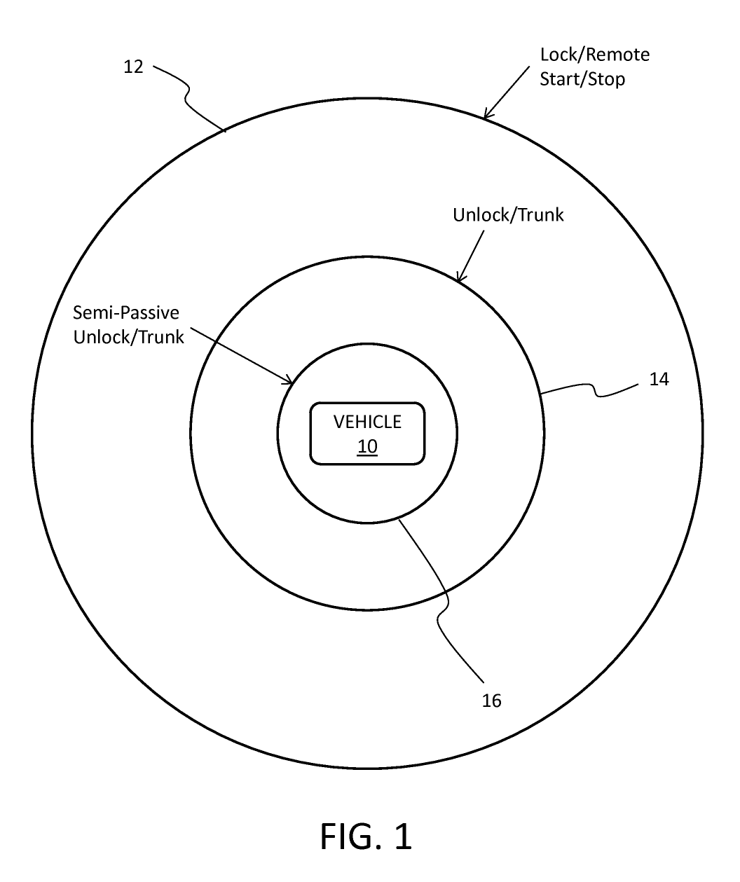

The basic setting for the present disclosure is considered in FIG. 1 in conjunction with the following description. Keyless fobs (also referred to as RKE (remote keyless entry) fobs) may include various operating ranges with respect to a vehicle 10. For example, fobs may include a maximum operable range as indicated by the outer range 12 in FIG. 1. For ease of explanation, reference is made to “manual fobs” in the sense that an actuator or button typically has to be depressed by the user within the operating range of the manual fob to concurrently trigger a corresponding function in the vehicle, e.g. trunk release, door unlock, door lock. Of course, if a manual keyless fob is out of range with respect to its corresponding vehicle or if the user's hands are not free to manually actuate the fob as the user approaches the vehicle, the manual fob cannot be applied to select a function associated therewith.

Within the outer range 12, manual fob operation may be used for certain vehicle functions, such as door lock, remote start/stop, car locating purposes or panic alarm situations. Additional vehicle functions may be available when manual fob operation is used within an inner range 14. These additional vehicle functions may include door unlock or trunk release. An aspect of the present disclosure is that there will be situations in which the user will want the ability to actuate a keyless fob function as the user approaches the vehicle without having to manually engage a pushbutton or signal actuator on the fob. For example, a user's hands could be encumbered while carrying purchased goods from a retail outlet to one's automobile. In such a situation, the user very well could be beyond the manual operating ranges (e.g., outer range 12 or inner range 14) when the user's hands are available to manually actuate the fob. Even if within range, the question of whether a user would want to open the trunk from a significant distance away from the vehicle could still be present.

Accordingly, one or more embodiments of the present disclosure provide a semi-passive entry system or semi-passive keyless fob as indicated in FIG. 1. The semi-passive characterization is intended to include a keyless fob that passively actuates the desired vehicle function as the user approaches the vehicle without any manual or hand held actuation required. The semi-passive function may be incorporated into the same fob having manual functionality, whereby the user may select either manual or semi-passive actuation. According to one or more embodiments, a semi-passive range 16 may be provided at a distance less than the manual operating ranges (e.g., outer range 12 or inner range 14). The semi-passive range 16 may be operable only within a relatively short distance of the vehicle 10, e.g. on the order of 5 meters. The reason for setting the semi-passive range to be relatively close to the vehicle 10 may be to accommodate a situation that involves a user approaching the vehicle 10 with hands not free and deciding for whatever reason that he/she may want to return to a store for something that has been forgotten, for example. In such a situation, the user would not want the trunk lid to open or doors to unlock while the forgotten item or other circumstance is being attended to.

The present disclosure is not intended to alter those operating ranges presently being used for manual keyless fobs. For example, relatively greater operating ranges, such as outer range 12, may be desired for manual fob operation when used for door lock, car locating purposes or panic alarm situations, which functions do not directly relate to the context in which the semi-passive functionality of the present disclosure is used. It is also believed that the more limited operating range of the semi-passive fob operation enhances safety. In other words, when one is approaching his/her automobile with hands encumbered, it may not necessarily be desirable to unlock the doors or the trunk lid when the user is within the inner range 14, but outside the semi-passive range 16.

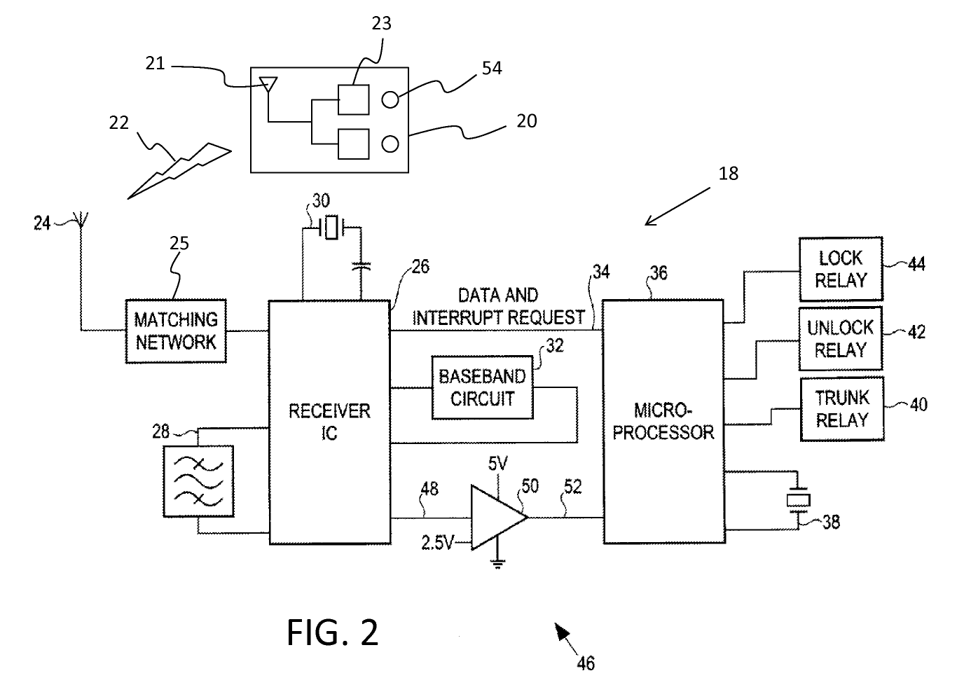

FIG. 2 is intended to set forth a block diagram of a receiver network 18 that would correspond to an RKE fob 20 having the semi-passive functionality of the present disclosure. The receiver network 18 of FIG. 2 may reside in the vehicle 10 to which the keyless fob 20 is mated. The receiver network 18 may be implemented as a dedicated receiver module or as part of a distributed system for the control of locking, unlocking, trunk release, etc. One or more keyless fobs 20 may be uniquely mated to a corresponding vehicle receiver for obvious security reasons. Such security measures can involve encryption systems and the like known to those skilled in the art.

The receiver network 18 may include receiver circuitry such as an antenna 24 and matching network 25 for receiving signals from the fob 20. The fob 20 may include a transmitter 21 for sending a signal 22 to antenna 24, such transmitter operating in response to user actuation of one or more pushbuttons 23 or other similar signal actuators. The signal 22 transmitted is coded for the function selected, i.e. door unlock, trunk opening, etc. Within the context of the present disclosure, the transmitted signal 22 may further include coding to indicate whether it was manually generated or semi-passively generated as considered hereinabove. The receiver network 18 may include additional receiver circuitry such as a receiver IC 26, an IF filter circuit 28, and a local oscillator (LO) circuit 30, as well as base band circuitry 32. A received signal passes on line 34 to microprocessor 36, which may include a resonator circuit 38. The microprocessor 36 may use the received signal to control for example, the vehicle trunk, unlock, and lock relays as respectively shown at 40, 42, and 44.

As well known to those skilled in the art, the receiver IC 26 may include a super-heterodyne architecture. In addition, a range detector 46 may be provided between receiver IC 26 and microprocessor 36. The range detector 46 may include RSSI (received signal strength indicator) circuitry. As discussed with respect to FIG. 1, the semi-passive functionality of the present disclosure may not be operable until the user is within the semi-passive range 16 of the vehicle. Accordingly, a fob 20 having semi-passive functionality may operate in conjunction with the receiver network 18 being able to determine whether the user (and fob) are within the semi-passive range 16 to the vehicle before any semi-passive selected function is triggered. The RSSI circuitry of the range detector 46 may receive an indication of the fob input signal strength on line 48. The fob semi-passive input signal strength to antenna 24/receiver IC 26 may increase as the fob 20 moves closer to the vehicle 10 with everything else being equal. The strength of the semi-passive input signal may be monitored on line 48 and may be compared in comparator 50 against a signal level strength equivalent to the fob transmitting the semi-passive signal at, for example, an outer limit of the semi-passive range 16. Accordingly, an output signal may be provided on line 52 to microprocessor 36 to indicate as a threshold matter whether the fob is inside or outside of the semi-passive range 16. In other words, even though a semi-passive signal may be received, if the semi-passive signal indicates that the fob is outside of the semi-passive range 16 from the vehicle, the corresponding functionality of the semi-passive signal will not be triggered by the microprocessor 36.

As indicated, the manual and semi-passive functionalities may be part of a single fob 20. For instance, the fob may be operable in a manual mode in response to manual actuation of a signal actuator for the manual mode, while the fob may be operable in a semi-passive mode in response to manual actuation of the signal actuator for the semi-passive mode. Manual actuation for the manual mode may be the same as in previously available devices—the fob 20 is pointed at the vehicle 10, a selected function pushbutton 23 is pressed or actuated, and a correspondingly transmitted signal 22 causes the selected function to occur if the vehicle 10 is within the permissible operating range of the fob transmitter for the selected function. Manual actuation for the semi-passive mode may differ from the manual actuation for the manual mode. According to one or more embodiments, when the user intends to take advantage of the fob's semi-passive functionality, the function pushbutton 23 may be depressed and held down to activate repetitious transmission of a semi-passive function signal. Such repetitious transmission could be designed to continue for a predetermined period of time. The fob 20 may include an LED 54 to confirm whether the repetitious semi-passive signal has been initiated. For example, the LED 54 on the fob 20 can be designed into the circuitry to provide, for example, one flash when the function pushbutton 23 has been held only long enough for a corresponding manual signal and could provide two flashes to confirm that the function pushbutton has been pressed or held down long enough to initiate a repetitious semi-passive signal. This arrangement avoids the need for two actuation buttons for each function—one for manual and one for semi-passive actuation. Furthermore, the duration of the repetitious semi-passive signal being transmitted could be extended by the user if, for example, the initial predetermined transmission duration was not deemed long enough. In this event, the user could again actuate or press down the function pushbutton 23 for sufficient duration to obtain confirmation (two flashes of LED 54) that the semi-passive signal transmission has again been called for, thereby extending the duration of the semi-passive functionality. LED 54 could alternatively be replaced by an electronic sound generator or a tactile vibration generator.

The semi-passive signal may be repetitiously transmitted in a continuous fashion when the fob 20 is beyond the semi-passive range 16 of the vehicle 10 and may result in the selected function occurring only when the user reaches the outermost limit of the semi-passive range 16. As shown in FIG. 1, the semi-passive range 16 may be smaller than the inner range 14 for manual fob operation. According to one or more alternate embodiments of the present disclosure, the semi-passive range 16 may be approximately equal to the inner range 14.

Furthermore, the vehicle receiver network 18 might only act on a semi-passive signal once during a repetitious semi-passive signal (or user extended) transmission cycle unless, during the cycle, a manual signal has been initiated. In other words, if the semi-passive trunk opening signal is being transmitted, it may continue to be transmitted after the trunk has opened and perhaps after it has then been closed. In this event, the continuation of the semi-passive signal to open the trunk may be of no effect for the balance of the semi-passive signal transmission cycle. On the other hand, once the semi-passive signal has timed out (end of the predetermined minute transmission cycle) or an interceding manual signal is received, another semi-passive signal generation cycle may be initiated by appropriate engagement of the pushbutton actuator.

Once the vehicle receiver network 18 acts on a semi-passive signal, vehicle 10 might provide feedback of such action to the user by, for instance, “chirping” the vehicle's horn or flashing the vehicle's exterior lights. Further, if vehicle 10 unlocks semi-passively but no door is opened for a predetermined time or before fob 20 moves a predetermined distance away from vehicle 10, the vehicle might automatically re-lock.

Triggering only one activation of the unlock motor or trunk release per semi-passive event may eliminate potential customer annoyance or damage to the lock/trunk motors that may otherwise occur due to continuous actuations. One way to achieve this is to have the fob 20 transmit the same stream for each repetition during a semi-passive signal transmission cycle. Accordingly, the fob 20 may continue to transmit each transmission with the same rolling code, control code, cyclic redundancy checks (CRCs), etc. The microprocessor 36 may then include control logic for ignoring repeated transmissions that use the same rolling code. According to one or more alternate embodiments, the control logic for ignoring repeated transmissions that use the same rolling code may be contained in the receiver IC 26 so that it relays only one trigger message to the microprocessor 36 to activate the unlock motor or trunk release per semi-passive event.

Another way to implement this logic may be to add a signal or message to the radio frequency (RF) protocol that signals the receiver network 18 that hands-free, semi-passive RKE is active as opposed to normal functionality. For example, the added message may signal the receiver network that the received transmission is for semi-passive functionality. Accordingly, only one activation of the unlock motor or trunk release may be carried out during the semi-passive signal transmission cycle.

While exemplary embodiments are described above, it is not intended that these embodiments describe all possible forms of the invention. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A keyless fob for use in a remote keyless entry system including a receiver, the receiver being mounted in a vehicle having a function, the fob comprising:
a manual signal actuator; and
a transmitter configured to:
transmit a manual signal for initiating a function in response to manual actuation of the signal actuator for a manual mode; and
repetitively transmit a semi-passive signal for a predetermined period of time for initiating the function in response to manual actuation of the signal actuator for a semi-passive mode, the semi-passive signal including a message indicating the semi-passive signal is for semi-passive functionality,
wherein a vehicle is adapted to initiate the function only once in response to receipt of the semi-passive signal by a receiver while the fob is spaced from the receiver by no more than a predetermined semi-passive range, and
wherein the predetermined period of time corresponds to an amount of time that enables hands-free initiation of the function after manual actuation of the signal actuator for the semi-passive mode outside of the semi-passive range.

2. The fob of claim 1, wherein the manual actuation of the signal actuator for the manual mode is different from the manual actuation of the signal actuator for the semi-passive mode.

3. The fob of claim 2, wherein the signal actuator is a pushbutton, the manual actuation for the manual mode includes depressing the pushbutton for a first period of time and the manual actuation for the semi-passive mode includes depressing the pushbutton for a second period of time longer than the first period of time.

4. The fob of claim 1, wherein the vehicle is adapted to initiate the function in response to receipt of the manual signal by the receiver while the fob is spaced from the receiver by no more than a predetermined manual operating range.

5. The fob of claim 4, wherein the manual operating range is greater than the semi-passive range.

6. The fob of claim 5, wherein the manual signal is stronger than the semi-passive signal.

7. The fob of claim 1, wherein the function is unlocking an entry to the vehicle.

8. A receiver for use in a remote keyless entry system including a keyless fob, the receiver being mounted in a vehicle having a function, the fob including a manual signal actuator and a transmitter for repetitively transmitting a wireless semi-passive signal for a predetermined period of time in response to manual actuation of the signal actuator for a semi-passive mode, the receiver comprising:
receiver circuitry configured to receive the semi-passive signal from a fob;
a range detector configured to detect whether the fob is spaced from the receiver by no more than a predetermined semi-passive range; and
a microprocessor configured to:
initiate the function in response to receipt of the semi-passive signal by the receiver circuitry while the fob is detected to be spaced from the receiver by no more than the predetermined semi-passive range, and
ignore repeated transmissions of a same semi-passive signal received by the receiver circuitry from the fob within the predetermined semi-passive range once the function is initiated,
wherein the predetermined period of time corresponds to an amount of time that enables hands-free initiation of the function after manual actuation of the signal actuator for the semi-passive mode outside of the predetermined semi-passive range.

9. The receiver of claim 8, wherein the range detector is further configured to detect that the fob is spaced from the receiver by no more than the predetermined semi-passive range when the semi-passive signal has at least a predetermined signal strength.

10. The receiver of claim 8, wherein the microprocessor is further configured to activate vehicle feedback upon initiation of the function in response to receipt of the semi-passive signal.

11. The receiver of claim 10, wherein the vehicle feedback includes audible feedback from a vehicle horn.

12. The receiver of claim 10, wherein the vehicle feedback includes visual feedback from vehicle lights.

13. The receiver of claim 8, wherein the function is unlocking an entry to the vehicle.

14. The receiver of claim 13, wherein the microprocessor is configured to lock the entry to the vehicle when a vehicle door is not opened within a second predetermined period of time following the initiation of the function.

15. The receiver of claim 13, wherein the microprocessor is configured to lock the entry to the vehicle when a vehicle door is not opened before the fob moves a predetermined distance away from the receiver.

16. The receiver of claim 15, wherein the predetermined distance is greater than the semi-passive range.

17. The receiver of claim 8, wherein the fob is operable in a manual mode in response to a second manual actuation of the signal actuator for the manual mode, the second manual actuation being different from the first-mentioned manual actuation for the semi-passive mode, wherein in the manual mode the transmitter transmits a wireless second signal in response to the second manual actuation of said signal actuator,
the receiver circuitry further configured to receive the second signal and the range detector further configured to detect whether the fob is spaced from the receiver by no more than a predetermined manual operating range, where the vehicle is adapted to initiate the function in response to receipt of the second signal by the receiver circuitry while the fob is detected to be spaced from the receiver by no more than the manual operating range.

18. The receiver of claim 17, wherein the manual operating range is greater than the semi-passive range.

19. The receiver of claim 17, wherein the second signal is stronger than the semi-passive signal.

20. A method for use in a remote keyless entry system including a keyless fob and a receiver mounted in a vehicle having a function, the fob including a manual signal actuator and a transmitter for repetitively transmitting a wireless semi-passive signal for a predetermined period of time in response to manual actuation of the signal actuator for a semi-passive mode, the method comprising:
receiving a plurality of semi-passive signals from a fob using receiver circuitry;
initiating the function in response to receipt of at least one of the plurality of semi-passive signals by the receiver circuitry while the fob is detected to be spaced from the receiver by no more than a predetermined semi-passive range; and
ignoring repeated transmissions of a same semi-passive signal received by the receiver circuitry from the fob within the predetermined semi-passive range once the function is initiated;
wherein the predetermined period of time corresponds to an amount of time that enables hands-free initiation of the function after manual actuation of the signal actuator for the semi-passive mode outside of the predetermined semi-passive range.
